(19) United States
(12) Patent Application Publication
(10) Pub. No.: US 2008/0085648 A1
(43) Pub. Date: Apr. 10, 2008

(54) Electric conductive material and method of producing the same

(75) Inventors: Shinsuke HIROSUE, Ueda-shi (JP); Masashi OKUBO, Ueda-shi (JP)

Correspondence Address: BIRCH STEWART KOLASCH & BIRCH, PO BOX 747, FALLS CHURCH, VA, 22040-0747, US

(73) Assignee: SHINANO KENSHI KABUSHIKI KAISHA

(21) Appl. No.: 11/905,693

(22) Filed: Oct. 3, 2007

(30) Foreign Application Priority Data
Oct. 4, 2006 (JP) 2006-272463
Sep. 6, 2007 (JP) 2007-231955

(51) Int. Cl. H01B 1/24; B05D 5/12; D03D 15/08; D04B 1/18; D04H 13/00

(52) U.S. Cl. 442/183; 252/510; 427/122; 442/306; 442/328

(57) ABSTRACT

The electric conductive material has flexibility and elasticity. Electric conductivity is less varied even if the electric conductive material is extended and shrunk. The electric conductive material of the present invention comprises an elastic spiral yarn being composed of organic fibers, and the yarn has been carbonized.

### BACKGROUND OF THE INVENTION

The present invention relates to an electric conductive material, which is elasticized without varying electric conductivity, and a method of producing the electric conductive material.

For example, a conventional flexible and elastic electric conductive material, e.g., electrode material, which is produced by mixing electric conductive fillers with an elastic material, e.g., rubber, elastomer, is known.

Japanese Utility Model Gazette No. 6-59488 discloses an electric conductive elastic unit, in which electric conductive fibers and non-conductive fibers are mixed at a constant rate and which is used as, for example, biomedical electrodes, sensor electrodes, etc.

Further, a method of producing flexible paper composed of spring-shaped fibers is known. Industrial Material 2005 Vol. 53 No. 9 (page 64-67) discloses a method of producing an elastic and flexible sheet. The elastic and flexible sheet is produced by the steps of: winding copper-ammonia-rayon fibers, which are cellulose fibers, on polyvinyl alcohol fibers, which act as core fibers; cutting the yarns to have a prescribed length; mixing the cut yarns with water; and forming the cut yarns into a sheet by a known papermaking process.

In a conventional flexible and elastic electrode material, e.g., electric conductive rubber, electric conductive elastomer, electric conductivity, flexibility and elasticity have a relationship with content of electric conductive fillers. In case of increasing the content of the electric fillers so as to improve electric conductivity, flexibility and elasticity of the material will be lowered; in case of reducing the content of electric conductive fillers, the electric conductivity of the material will be lowered.

In the electrode material of the Japanese Utility Model Gazette No. 6-59488, the elasticity and electric conductivity have distinct anisotropy in the warp direction and the weft direction. In case of extending the material in one of the directions, the material must be shrunk in the other direction. Namely, it is impossible to simultaneously extend the material in the warp direction and the weft direction. Therefore, use of the material must be limited.

In the method disclosed in Industrial Material 2005 Vol. 53 No. 9, the fibers whose shapes can be fixed are limited. Further, the coil shapes of the fibers cannot be maintained after performing the papermaking process.

### SUMMARY OF THE INVENTION

The present invention was conceived to solve the above described problems.

An object of the present invention is to provide a flexible and elastic electric conductive material, in which electric conductivity is less varied even if the material is extended and shrunk.

Another object of the present invention is to provide a method of producing said electric conductive material.

To achieve the objects, the present invention has following structures.

Namely, the electric conductive material of the present invention comprises an elastic spiral yarn being composed of organic fibers, and the yarn has been carbonized.

Another electric conductive material of the present invention comprises a flexible and elastic knitted, woven or unwoven fabric being composed of spiral yarns, which are composed of organic fibers, and the fabric has been carbonized. The fabric may be elasticized in two axial directions thereof.

Preferably, spiral-winding number of the yarn is 10²-10⁶ times per meter.

Preferably, the yarn is a silk yarn. Especially, the silk yarn may be a spun silk yarn.

The method of producing an electric conductive material comprising the steps of: spirally winding a yarn composed of organic fibers on a core member; and carbonizing the yarn until said yarn is carbonized, whereby said core member is removed during said carbonizing step and said electric conductive material is elasticized.

Another method of producing an electric conductive material comprises the step of: spirally winding a yarn composed of organic fibers on a core member; producing a knitted, woven or unwoven fabric composed of the yarns; removing the core member from the fabric; then carbonizing the fabric until said fabric is carbonized, whereby said electric conductive material is made flexible and elasticized.

In this method, the core members may be composed of water-soluble vinylon yarns, and the core members may be removed by soaking the fabric in a hot bath so as to dissolve the core members.

Further, the method of producing an electric conductive material comprises the steps of: spirally winding a yarn composed of organic fibers on a core member; producing a knitted, woven or unwoven fabric composed of the yarns; carbonizing the fabric until said fabric is carbonized, whereby said core member is removed during said carbonizing step and said electric conductive material is made flexible and elasticized.

In each of the methods, a plurality of the yarns, which are spirally wound on the core member, can be suitably used.

In each of the methods, the core member, whose diameter is 2-1000 times as thick as that of the yarn, can be suitably used.

By employing the electric conductive material and the method of the present invention, the flexible and elastic electric conductive material, in which electric conductivity is less varied even if the material is extended and shrunk, can be provided.

### BRIEF DESCRIPTION OF THE DRAWINGS

Embodiments of the present invention will now be described by way of examples and with reference to the accompanying drawings, in which:

FIG. 1 is a graph of external forces with respect to extension strains of electric conductive spiral yarns in the present invention;

FIG. 2 is a graph of electrical resistance values with respect to extension strains of electric conductive spiral yarns in the present invention;

FIG. 3 is a graph of external forces with respect to extension strains in the weft directions of the electric conductive fabric in the present invention and of the conventional electric conductive fabrics;

FIG. 4 is a graph of external forces with respect to extension strains in the warp directions of the electric conductive fabric in the present invention and of the conventional electric conductive fabrics;

FIG. 5 is a graph of electrical resistance values with respect to extension strains in the weft directions of the electric conductive fabric in the present invention and of the conventional electric conductive fabrics;

FIG. 6 is a graph of electrical resistance values with respect to extension strains in the warp directions of the electric conductive fabric in the present invention and of the conventional electric conductive fabrics;

FIG. 7 is an enlarged photograph of a braided thread constituted by one polyethylene yarn (400 denier) and three spun silk yarns (140/two-folded yarns) before carbonizing, which are produced in Example 3;

FIG. 8 is an enlarged photograph of the braided thread constituted by one polyethylene yarn (400 denier) and three spun silk yarns (140/two-folded yarns) after carbonizing, which are produced in Example 3;

FIG. 9 is an enlarged photograph of a braided thread constituted by one polyethylene yarn (400 denier) and two spun silk yarns (140/two-folded yarns) before carbonizing, which are produced in Example 4;

FIG. 10 is an enlarged photograph of the braided thread constituted by one polyethylene yarn (400 denier) and two spun silk yarns (140/two-folded yarns) after carbonizing, which are produced in Example 4; and

FIG. 11 is a graph of external forces and resistance values with respect to extension strains of a carbonized spiral yarn, which are produced in Example 4.

### DETAILED DESCRIPTION OF THE EMBODIMENTS

Preferred embodiments of the present invention will now be described in detail with reference to the accompanying drawings.

Firstly, a first method of producing the electric conductive material of the present invention comprises the steps of: forming a knitted, woven or unwoven fabric composed of yarns, each of which is composed of organic fibers and spirally wound on a core member; removing the core members; and carbonizing the fabric, so that the flexible and elastic electric conductive material can be produced.

Namely, the yarns, each of which is composed of organic fibers, are spirally wound on core members respectively. In this state, the yarns are formed into the knitted, woven or unwoven fabric. This step can be performed by a conventional apparatus for forming a knitted, woven or unwoven fabric.

Next, the core members are removed from the fabric.

To remove the core members, the core members are made of water-soluble yarns. By soaking the fabric in a hot bath, the core members are dissolved and easily removed. By controlling conditions of dissolving the core members and drying the yarns, the spiral shape of the yarns can be maintained.

Next, the fabric, from which the core members have been removed, is carbonized, in a furnace, under a nonoxidative atmosphere until the fabric is carbonized. By this step, the fabric-shaped electric conductive material composed of carbon is completed. By carbonizing the fabric, the spiral shapes of the yarns can be fixed.

By suitably setting carbonizing conditions, e.g., temperature, time period, electric conductivity of the electric conductive material can be adjusted. Namely, in case of carbonizing at high temperature, the electric conductivity of the electric conductive material can be improved; in case of carbonizing at low temperature, the electric conductivity of the electric conductive material is lowered. Therefore, the carbonizing conditions may be properly set on the basis of use of the electric conductive material.

The organic yarns may be composed of natural fibers or synthetic fibers.

Silk yarns may be suitably used as the natural yarns. Namely, a highly flexible carbonized fabric can be produced by carbonizing the fabric composed of silk yarns. To maintain the spiral shapes of the yarns, spun silk yarns are suitable. Each of the spun silk yarn is formed by twisting short fibers. The spun silk yarns do not have large stiffness, so their spiral shapes can be properly maintained.

Further, cellulose fibers may be used as the natural fibers.

By the above described method, the fabric-shaped electric conductive material composed of the carbonized spiral yarns can be produced. The electric conductive material is a flexible and elastic. Further, the electric conductivity is less varied even if the material is extended and shrunk. The electric conductive material, which is produced from the knitted or woven fabric, can be elasticized in two axial directions thereof; the electric conductive material, which is produced from the unwoven fabric, can be elasticized in every direction.

Even if the electric conductive material is extended or shrunk, the spiral shapes are extended and compressed without changing the lengths of the yarns, so that the electric conductivity is less varied.

In case of using mere straight yarns instead of the spiral yarns, a woven fabric can be slightly extended and shrunk in oblique directions, but not extended and shrunk in the warp direction and the weft direction. An unwoven fabric can be slightly extended and shrunk in every direction. A knitted fabric has elasticity, but has anisotropy, so use of the electric conductive material must be limited.

In the electric conductive material of the present invention, the carbonized spiral yarns can be extended and shrunk. Therefore, the woven fabric composed of the carbonized spiral yarns can be extended and shrunk in the warp direction and the weft direction without mutual interruption.

Since the yarns can be extended and shrunk in the warp direction and the weft direction without mutual interruption, the electric conductive material can have a wide array of uses.

For example, the electric conductive material may be used as an electrode material of an electrostriction actuator composed of a high polymer sheet. In the electrostriction actuator, the electrodes are respectively attached to the both surfaces of the high polymer sheet, and the high polymer sheet is deformed by applying electric power to the electrodes. By employing the electrodes made of the electric conductive material of the present invention, the electrodes can be extended and shrunk in the two-axial directions, etc., so that the high polymer sheet can be freely deformed.

The electric conductive material may be used as electrodes of sensors, which will be attached to human bodies. The electrodes can deform and follow movement of the human body, so the sensors are not badly influenced.

Preferably, a diameter of each of the core members (core yarns) is 2-1000 times as thick as that of the yarn to be wound on the core member. By using large-diameter core member, a diameter of the spiral yarn (coiled yarn) is increased, so that flexibility is also improved. Further, the flexibility can be improved by using the thinner spiral yarns. By using the core members whose diameter is 2-1000 times as thick as that of the yarn to be wound, the flexibility of the electric conductive material can be adjusted on the basis of uses thereof.

Preferably, spiral-winding number of each of the spiral yarns, which is composed of the organic fibers, is 10²-10⁶ times per meter. The flexibility can be improved by increasing the spiral-winding number.

The spiral yarns, whose spiral shapes are fixed, have elasticity as well as coil springs. By changing the diameter of the yarns, the spiral-winding number thereof, the material thereof, etc., physical or mechanical characteristics of the electric conductive material can be controlled.

The electric conductivity of the electric conductive material can be controlled by changing the material of the yarns, the carbonizing conditions, density of the fabric (numbers of the warp yarns and the weft yarns per unit length), etc.

In the first method, the electrode material is produced by the steps of: forming the knitted, woven or unwoven fabric composed of the yarns, each of which is composed of organic fibers and spirally wound on the core member; removing the core members; and carbonizing the fabric. In a second method, the core members are dissolved and removed during the step of carbonizing the fabric.

Namely, the core members in the second method are composed of an organic material which can be gasified at the carbonizing temperature. For example, polyethylene yarns may be used as the organic material.

In the above described methods, the knitted, woven or unwoven fabric composed of the yarns, each of which is composed of organic fibers and spirally wound on the core member, is carbonized so as to produce the fabric-shaped electric conductive material. In another case, a wire-shaped electric conductive material can be produced by carbonizing the yarn, which is composed of organic fibers and spirally wound on the core member, until the yarn is carbonized. In this case, the core member may be removed during the carbonizing step. Namely, the core members may be composed of an organic material which can be gasified at the carbonizing temperature. For example, polyethylene yarns may be used as the organic material.

Preferably, in the above described embodiments, two yarns, which are S-twisted or Z-twisted yarns of Example 4 (described later), or three yarns, which constitute a braided thread of Example 3 (described later), are spirally wound on each of the core members. If the yarn to be wound has larger diameter than the core member, spiral-winding number of the yarn is limited to a small number. The spiral-winding number influences the flexibility and maximum extension rate of the coiled yarn. Preferably, a small-diameter yarn, which will be carbonized, is spirally wound on a large-diameter core member so as to produce a flexible electric conductive material. However, the electric conductivity of the small-diameter yarn is low. To solve this problem, a plurality of yarns may be wound, so that the electric conductive material having high flexibility and high electric conductivity can be produced.

In case that one yarn is wound on each of the core members, each of the yarns has low electric conductivity and low mechanical strength. However, in case that the yarns are formed into a fabric and the fabric is carbonized, the fabric can be practically used. Further, in case of carbonizing the single yarn so as to produce a wire-shaped electric conductive material, the large-diameter single yarn is suitable.

On the other hand, in case that four or more yarns are wound on a core member, elasticity must be lowered. And, the yarns entirely cover an outer circumferential face of the core member, so it is difficult to remove the core member. Further, in case that four or more yarns are wound on the core member, productivity of twisting the yarns must be lowered.

### Example 1

Core members were water-soluble vinylon yarns (600 denier); spun silk yarns (EC 140/two-folded yarns) were spirally wound on the core members; spiral-winding number of each of the spun silk yarns was 1500 times per meter; and the wounded spun silk yarns were used as warp yarns and weft yarns so as to form a flat woven fabric, in which density of the warp yarns was 37 pieces/inch and that of the weft yarns was 34 pieces/inch. A sample of the electric conductive material was produced by the steps of: soaking the fabric into a hot bath, whose temperature was 70° C., so as to remove the water-soluble vinylon yarns; drying the fabric; primarily carbonizing the dried fabric in a furnace, under a nonoxidative atmosphere, for six hours at 700° C.; cooling the fabric until reaching the room temperature; and secondarily carbonizing the fabric for three hours at 1400° C. so as to carbonize the fabric. With this method, the fabric-shaped sample, which was composed of carbonized spiral yarns and whose thickness was 0.35 mm, was produced.

### Example 2

Core members were water-soluble vinylon yarns (300 denier); spun silk yarns (EC 140/two-folded yarns) were spirally wound on the core members; spiral-winding number of each of the spun silk yarns was 1500 times per meter; and the wounded spun silk yarns were used as warp yarns and weft yarns so as to form a flat woven fabric, in which density of the warp yarns was 50 pieces/inch and that of the weft yarns was 47 pieces/inch. A sample of the electric conductive material was produced by the steps of: soaking the fabric into the hot bath, whose temperature was 70° C., so as to remove the water-soluble vinylon yarns; drying the fabric; primarily carbonizing the dried fabric in the furnace, under a nonoxidative atmosphere, for six hours at 700° C.; cooling the fabric until reaching the room temperature; and secondarily carbonizing the fabric for three hours at 1400° C. so as to carbonize the fabric. With this method, the fabric-shaped sample, which was composed of carbonized spiral yarns and whose thickness was 0.34 mm, was produced.

### Comparative Example 1

A sample of the electric conductive material was produced by the conventional production steps of: primarily carbonizing a plain-circular-knitted fabric (spun silk yarns MC210/two-folded yarns/32 gauge) in the furnace, under a nonoxidative atmosphere, for six hours at 700° C.; cooling the fabric until reaching the room temperature; and secondarily carbonizing the fabric for three hours at 1400° C. so as to carbonize the fabric. With this method, the fabric-shaped sample, which was composed of carbonized spiral yarns and whose thickness was 0.15 mm, was produced.

### Comparative Example 2

Another sample of the electric conductive material was produced by the conventional production steps of: primarily carbonizing a silk-fraise-knitted fabric (spun silk yarns MC210/two-folded yarns/22 gauge) in the furnace, under a nonoxidative atmosphere, for six hours at 700° C.; cooling the fabric until reaching the room temperature; and secondarily carbonizing the fabric for three hours at 1400° C. so as to carbonize the fabric. With this method, the fabric-shaped sample, which was composed of carbonized spiral yarns and whose thickness was 0.32 mm, was produced.

### (External Force and Electrical Resistance to Extension Strain)

External forces and electrical resistance values with respect to extension strain of the above described samples were measured. Each of the samples was cut and formed into a strip-shaped sample, whose width was 10 mm. The strip-shaped samples were arranged at intervals of 10 mm and fixed by an upper metallic jig and a lower metallic jig. A digital force gauge, which was connected to the upper metallic jig by an insulation shaft, was vertically moved upward so as to measure external forces while the samples were extended. Further, the upper metallic jig and the lower metallic jig were connected to an electric power source so as to form a electrical circuit including the samples. Electrical resistance values were calculated, by Ohm's law, on the basis of input voltage and current measured while the samples were extended.

Note that, “extension strain” is defined by the following formula:

Extension strain=(a length of the extended sample−an initial length thereof)/(the initial length thereof)

The initial lengths of the samples were 10 mm.

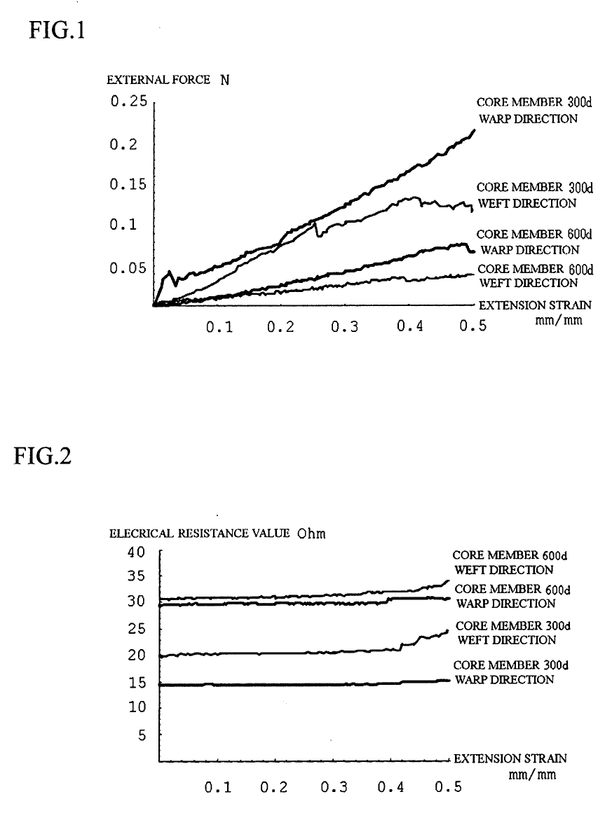

The measurement results are shown in FIGS. 1-6.

FIGS. 1 and 2 respectively show graphs of the external forces and the electrical resistance values with respect to the extension strains of the samples composed of the spiral yarns, which were produced in Examples 1 and 2.

In FIG. 1, smaller extension strain to the external force shows better flexibility. In case of using the thicker core member (600 denier), the flexibility of the electric conductive material was greater.

According to FIG. 2, the electrical resistance values were almost constant without reference to the extension strains. Namely, the electric conductivity was not varied by extension and shrink of the electric conductive material. Further, the electrical resistance value of the fabric-shaped electric conductive material having high yarn density (Example 2: 300 denier) was low. Namely, the fabric-shaped electric conductive material made from high yarn density fabric had superior electric conductivity.

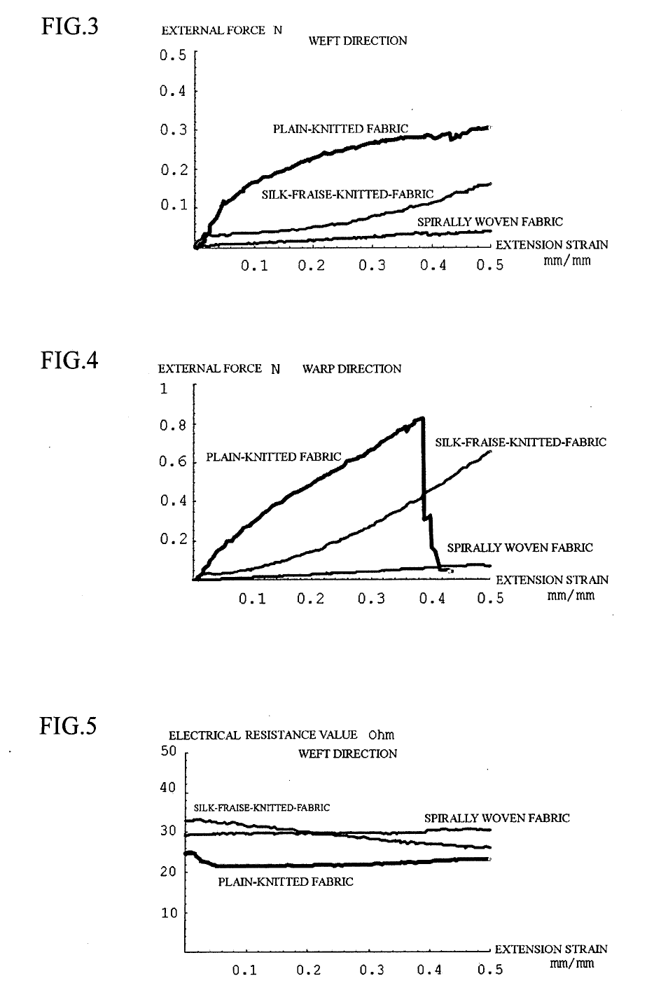

FIGS. 3-6 show graphs of external forces and resistance values with respect to extension strains of the samples of Example 1 and Comparative Examples 1 and 2 in one axial direction.

According to FIGS. 3 and 4, the fabric-shaped electric conductive material of Example 1 (the woven fabric composed of the spiral yarns) had better flexibility in both of the warp direction and the weft direction than other samples.

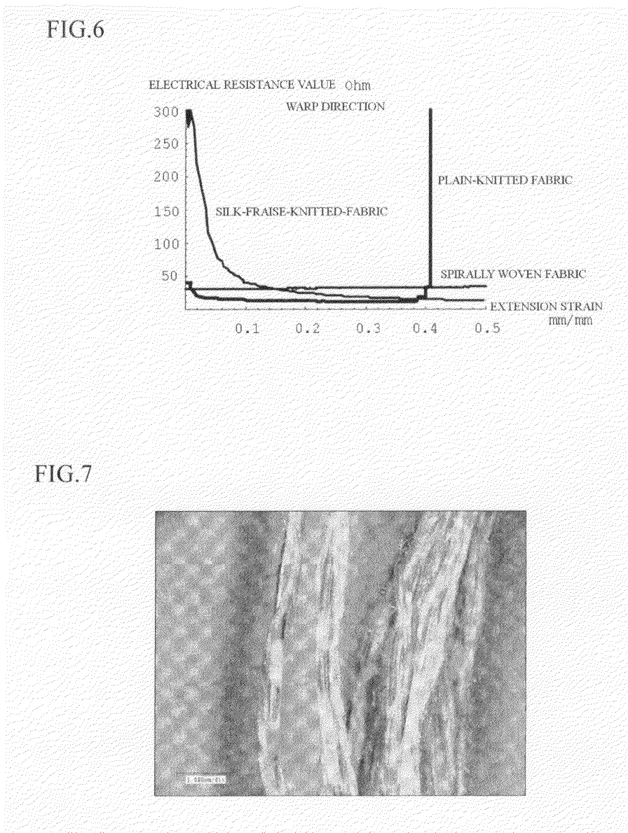

According to FIGS. 5 and 6, the electrical resistance value of the electric conductive material of Example 1 was almost constant even if the material was extended in every direction. Namely, the flexibility was less varied.

Note that, according to FIGS. 2, 5 and 6, the electrical resistance value of the electric conductive material of Example 1 was 30 Ω/cm or less, so it has enough electric conductivity.

When the samples of Comparative Examples, which were conventional fabrics, were extended in the vertical direction, they were shrunk in the horizontal direction. On the other hand, even if the samples of Examples were extended in the vertical direction, they were not shrunk in the horizontal direction. In the case of the samples of Examples in present invention, each of the spiral yarns could be solely extended and shrunk, so the extension and shrink in one direction was occurred without reference to those in the other direction. Therefore, the electric conductive materials of Examples 1 and 2 can be elasticized in two axial directions.

In the samples of Examples in present invention, the electrical resistance values were constant in spite of extending a distance between measuring terminals. Lengths of the samples were varied by the extension and the shrink, but the actual lengths of the yarns were not varied. Namely, lengths of electric paths were not varied.

### Example 3

A core member was a polyethylene yarn (400 denier); and three spun silk yarns (140/two-folded yarns) were spirally wound on the core member so as to form a braided thread. The thread was burned in the furnace, under a nonoxidative atmosphere, for six hours at 700° C.

FIG. 7 is an enlarged photograph of the braided thread before carbonizing; and FIG. 8 is an enlarged photograph of the braided thread after carbonizing. In FIG. 7, the spun silk yarns tangled with the large-diameter polyethylene yarn having a smooth surface. In the braided thread in FIG. 8, the polyethylene yarn was removed, so only carbon fibers, which were formed by carbonizing the spun silk yarns, were left. The carbon fibers can be used as the wire-shaped electric conductive materials.

### Example 4

A core member was a polyethylene yarn (400 denier); and one spun silk yarn (EC140/two-folded yarns) was spirally wound, on the core member, in a Z-twisting direction with spiral-winding number of 1500 times per meter; and another spun silk yarn (EC140/two-folded yarns) was spirally wound, on the silk yarn wound on the core member, in a S-twisting direction with spiral-winding number of 1500 times per meter.

A sample of the electric conductive material was produced by the steps of: primarily carbonizing the yarns in the furnace, under a nonoxidative atmosphere, for six hours at 700° C.; cooling the fabric until reaching the room temperature; and secondarily carbonizing the yarns for three hours at 1400° C. so as to carbonize the yarns. With this method, the wire-shaped sample, which was composed of carbonized fibers, was produced. The carbon fibers can be used as the wire-shaped electric conductive materials.

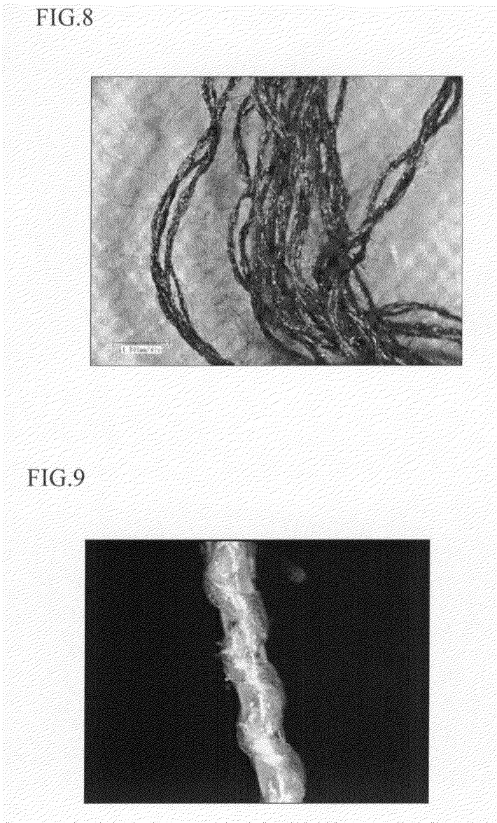

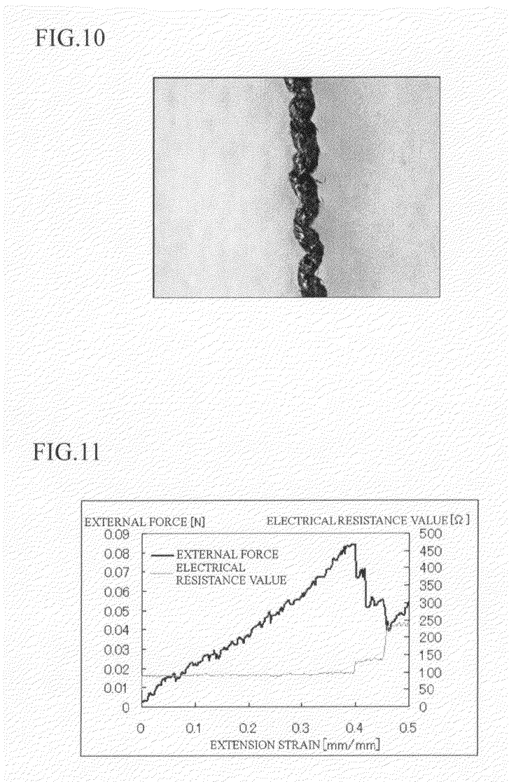

FIG. 9 is an enlarged photograph of the yarns before carbonizing; and FIG. 10 is an enlarged photograph of the yarns after carbonizing. By carbonizing the yarns, the spun silk yarns were carbonized, and the polyethylene yarn, which acted as the core member, was removed.

### (External Force and Electrical Resistance to Extension Strain)

External forces and electrical resistance values with respect to extension strain of the above described samples (the carbonized spiral yarns) were measured. The samples were arranged at intervals of 10 mm and fixed by the upper metallic jig and the lower metallic jig. The digital force gauge, which was connected to the upper metallic jig by the insulation shaft, was vertically moved upward so as to measure external forces while the samples were extended. Further, the upper metallic jig and the lower metallic jig were connected to the electric power source so as to form a electrical circuit including the samples. Electrical resistance values were calculated, by Ohm's law, on the basis of input voltage and current measured while the samples were extended.

The measurement results are shown in FIG. 11. According to FIG. 11, the flexible and elastic electric conductive material can be produced.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. An electric conductive material,
comprising:
an elastic spiral yarn being composed of organic fibers,
wherein said yarn has been carbonized.

2. An electric conductive material,
comprising:
a flexible and elastic knitted, woven or unwoven fabric being composed of spiral yarns, which are composed of organic fibers,
wherein said fabric has been carbonized.

3. The electric conductive material according to claim 2,
wherein said fabric can be elasticized in two axial directions thereof.

4. The electric conductive material according to claim 2,
wherein spiral-winding number of said spiral yarn is 10²-10⁶ times per meter.

5. The electric conductive material according to claim 2,
wherein said spiral yarn is a silk yarn.

6. The electric conductive material according to claim 5,
wherein said silk yarn is a spun silk yarn.

7. A method of producing an electric conductive material,
comprising the steps of:
spirally winding a yarn composed of organic fibers on a core member; and carbonizing the yarn until said yarn is carbonized,
whereby said core member is removed during said carbonizing step and said electric conductive material is elasticized.

8. A method of producing an electric conductive material,
comprising the step of:
spirally winding a yarn composed of organic fibers on a core member; producing a knitted, woven or unwoven fabric composed of the yarns; removing the core member from the fabric; then carbonizing the fabric until said fabric is carbonized,
whereby said electric conductive material is made flexible and elasticized.

9. A method of producing an electric conductive material,
comprising the steps of:
spirally winding a yarn composed of organic fibers on a core member; producing a knitted, woven or unwoven fabric composed of the yarns; carbonizing the fabric until said fabric is carbonized,
whereby said core member is removed during said carbonizing step and said electric conductive material is made flexible and elasticized.

10. The method according to claim 8,
wherein the core members are composed of water-soluble vinylon yarns, and
the core members are removed by soaking said fabric in a hot bath so as to dissolve the core members.

11. The method according to claim 7,
wherein a plurality of said yarns are spirally wound on the core member.

12. The method according to claim 8,
wherein a plurality of said yarns are spirally wound on the core member.

13. The method according to claim 9,
wherein a plurality of said yarns are spirally wound on the core member.

14. The method according to claim 7,
wherein a diameter of the core member is 2-1000 times as thick as that of said yarn.

15. The method according to claim 8,
wherein a diameter of the core member is 2-1000 times as thick as that of said yarn.

16. The method according to claim 9,
wherein a diameter of the core member is 2-1000 times as thick as that of said yarn.

17. The method according to claim 7,
wherein spiral-winding number of said yarn is 10²-10⁶ times per meter.

18. The method according to claim 8,
wherein spiral-winding number of said yarn is 10²-10⁶ times per meter.

19. The method according to claim 9,
wherein spiral-winding number of said yarn is 10²-10⁶ times per meter.

20. The method according to claim 7,
wherein said yarn is a silk yarn.

21. The method according to claim 8,
wherein said yarn is a silk yarn.

22. The method according to claim 9,
wherein said yarn is a silk yarn.

23. The method according to claim 20,
wherein said silk yarn is a spun silk yarn.

24. The method according to claim 21,
wherein said silk yarn is a spun silk yarn.

25. The method according to claim 22,
wherein said silk yarn is a spun silk yarn.
